(19) United States
(12) Patent Application Publication
(10) Pub. No.: US 2007/0066280 A1
(43) Pub. Date: Mar. 22, 2007

(54) Connection management system, method and program

(76) Inventor: Yasuyuki Arai, Kawasaki-shi (JP)

Correspondence Address: FREESCALE SEMICONDUCTOR, INC.;LAW DEPARTMENT, 7700 WEST PARMER LANE MD:TX32/PL02, AUSTIN, TX, 78729, US

(21) Appl. No.: 11/524,362

(22) Filed: Sep. 20, 2006

(30) Foreign Application Priority Data
Sep. 21, 2005 (JP) 2005-273873

(51) Int. Cl. H04M 1/66

(52) U.S. Cl. 455/411; 713/168

(57) ABSTRACT

A connection management system for efficiently managing registration data used to authorize communication between a wireless communication device and a wireless terminal in a secure manner. A wireless terminal registration server includes a wireless terminal data storage unit that stores a MAC address for which connection is permitted. An access point that has received a communication request from a wireless terminal transmits a connection authorization request to the wireless terminal registration server. The wireless terminal registration server executes an authorization process and notifies the access point whether or not to permit connection. The access point registers the MAC address for which connection is permitted in the authorization data storage unit and begins wireless communication with the wireless terminal. For subsequent communication requests, the access point executes the authorization process with the authorization data storage unit.

### BACKGROUND OF THE INVENTION

The present invention relates to wireless communication techniques, and more particularly, to a connection management system, a connection management program, and a connection management method for managing registration data used for connection authorization that is performed to secure communication between an access point and a wireless terminal.

In order to provide wireless communications between electronic devices with high-speed and convenient features, a variety of wireless communication techniques are used. Such wireless communication techniques are applied not only in offices but also in households. A wireless communication technique applied to short-distance wireless communication enables two relatively distant points to communicate with each other when the two points are in a predetermined range (e.g., a few hundred meters). In this case, when one device tries to communicate with its communication target in areas with a high density of houses and offices, there may be a large number of other wireless communication terminals within the range of the device. Under such circumstances, a wireless terminal provided with a wireless communication function provides authorization to its communication target before commencing communication. The wireless terminal activates application software for specifying the communication target, provides authorization to the communication target, and communicates with the authorized target terminal.

To enable such authorization, communication devices are required to register their communicable target devices. One example of an authorization method is media access control (MAC) address authorization, which uses a 48-bit MAC address assigned uniquely to a network card (refer to “802.11 High-speed Wireless LAN Textbook” supervised by Hideaki Matsue and Masahiro Morikura, IDG Joho Tsushin Series (IDG Information and Communications Series), IDG Japan, Inc. March, 2003, pp. 201-242). The MAC address authorization requires MAC addresses of clients wireless devices to be registered beforehand in an access point (wireless communication device). The access point enables communication with only registered MAC addresses and disables connection with other devices. The MAC address authorization is also referred to as “MAC address filtering”. This method limits connectable clients and prevents unauthorized access.

With the widespread use of terminals provided with wireless communication functions, wireless communication may be performed between a large number of terminals with high flexibility. When a new wireless communication device is added to such an environment, registration for enabling mutual authorization must be performed for every new wireless communication path.

However, due to the number of wireless devices used in households or offices, the number of wireless communication paths that must be set is increasing. This requires a large workload for registering a new wireless terminal in wireless communication devices that are scattered throughout a household or an office. Further, when, for example, a registered wireless terminal is discarded, its registration must be deleted. Thus, a large workload is required for managing such registration information. Accordingly, there is a demand for a simple wireless communication device management method.

### SUMMARY OF THE INVENTION

It is an object of the present invention to provide a connection management system, a connection management program, and a connection management method for efficiently managing registration data used for connection authorization performed to secure communication between a wireless communication device and a wireless terminal.

One aspect of the present invention is a connection management system for performing wireless terminal connection authorization through wireless communication. The system is provided with a wireless terminal registration server including a registration data storage means for storing data related to a wireless terminal identifier that permits connection. An access point is connected to the wireless terminal registration server through a network. A wireless terminal performs wireless communication with the access point. The access point includes an authorization data storage means for storing the data related to the wireless terminal identifier that permits connection. A connection authorization means performs connection authorization when receiving a connection request including data related to the wireless terminal identifier from the wireless terminal based on whether the wireless terminal identifier has been registered in the authorization data storage unit. A transmission means transmits a connection authorization request including the data related to the wireless terminal identifier to the wireless terminal registration server when the connection authorization is unsuccessful. A registration means registers the wireless terminal identifier in the authorization data storage means when receiving a connection permission from the wireless terminal registration server based on registration of the wireless terminal identifier in the registration data storage means.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a circuit diagram of a system according to a preferred embodiment of the present invention;

FIG. 2 is a schematic diagram of data stored in a wireless terminal data storage unit;

FIG. 3 is a schematic diagram of data stored in an authorization data storage unit;

FIG. 4 is a schematic diagram showing a registration process performed in the preferred embodiment;

FIG. 5 is a schematic diagram showing a connection authorization process performed in the preferred embodiment;

FIG. 6 is a schematic diagram showing a connection authorization process performed in the preferred embodiment; and

FIG. 7 is a schematic diagram showing a deletion process performed in the preferred embodiment.

### DETAILED DESCRIPTION OF THE PREFERRED EMBODIMENTS

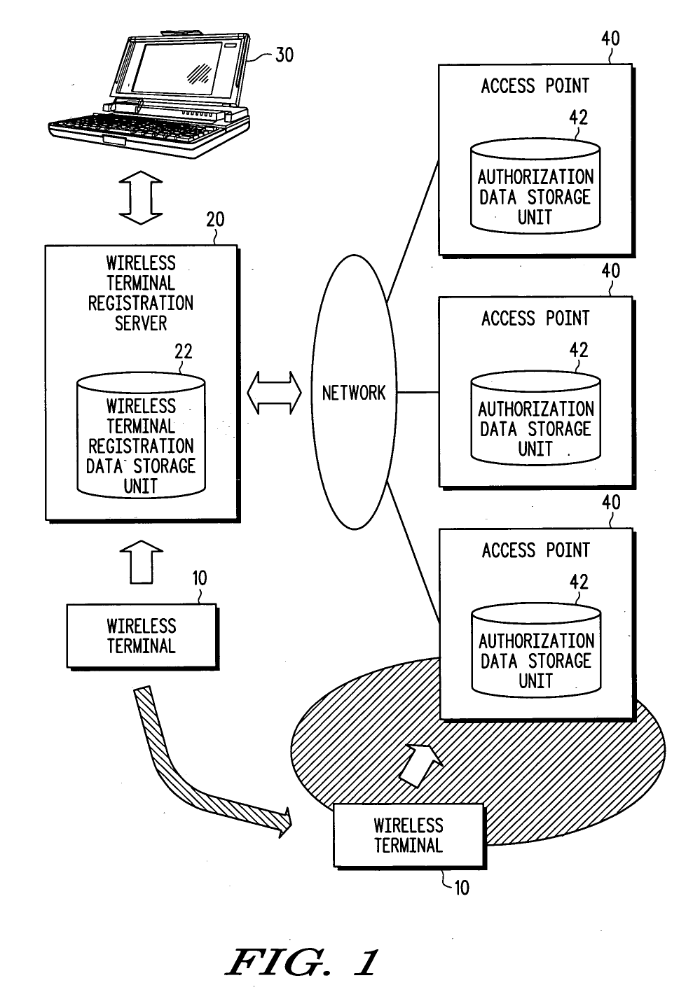

A preferred embodiment of the present invention will now be described with reference to FIGS. 1 to 7. In the preferred embodiment, a connection management system, a connection management program, and a connection management method in which the present invention is embodied will be described. The connection management system, program, and method are used to manage connection of a wireless terminal that wirelessly communicates with a plurality of access points installed in households or companies.

In the preferred embodiment, wireless communication is performed with a wireless terminal 10 and access points 40, as shown in FIG. 1. A wireless terminal registration server 20, which is connected to the access points 40 by a network, is used for connection management of the wireless communication. The network may be a wired or wireless network. Further, an operational terminal 30 is connected to the wireless terminal registration server 20.

The wireless terminal 10 is a wireless communication terminal provided with a wireless communication function. The wireless terminal 10 wirelessly communicates with the access points 40. The wireless terminal 10 is also a data terminal having other functions such as functions for transmitting data via a network and displaying received data. The data terminal may be a computer terminal like a notebook personal computer, a portable telephone terminal, or a portable television. The application of the data terminal is not limited. The wireless terminal 10 includes, in addition to a CPU, a RAM, and a ROM (not shown), an input device such as a keyboard and a mouse, an output device such as a display, and a communication device.

The wireless terminal registration server 20 is a computer system that performs processing of various data associated with connection authorization of the wireless terminal 10. The wireless terminal registration server 20 exchanges information, such as registration information of the wireless terminal 10 and connection requests from the wireless terminal 10, with the access points 40 to manage various types of data for management of the wireless terminal 10. The wireless terminal registration server 20, which includes a CPU, a RAM, and a ROM (not shown), performs processing including a step of checking the registration of a wireless terminal identifier in a registration data storage unit and a step of transmitting a connection permission based on the registration. The wireless terminal registration server 20 executes management programs to function as a registration checking unit for checking registration of a wireless terminal identifier and to function as a connection permission transmission unit for transmitting a connection permission.

The wireless terminal registration server 20 further includes a wireless terminal data storage unit 22, which serves as the registration data storage unit. Referring to FIG. 2, the wireless terminal data storage unit 22 stores wireless terminal registration data 220 relating to the wireless terminal 10 that is permitted to access the access points 40. The wireless terminal registration data 220 is stored in the wireless terminal data storage unit 22 when the wireless terminal 10 is newly registered. The wireless terminal registration data 220 is deleted when the wireless terminal 10 is discarded. For each network card included in the wireless terminal 10, the wireless terminal registration data 220 includes data related to the MAC address, applicable communication format, and applicable access points that may be used.

A MAC address data region of the wireless terminal registration data 220 stores data of an identifier that is uniquely assigned to the network card of the wireless terminal 10 that is permitted to use the access points 40.

The applicable communication format data region of the wireless terminal registration data 220 stores data for specifying the communication format that enables communication with use of the MAC address.

The applicable access point data region of the wireless terminal registration data 220 stores data for specifying the access points 40 that may be used to communicate with the applicable communication format. Identifiers uniquely assigned to the access points 40 are used in the applicable access point data region.

The operational terminal 30, which serves as a correcting unit, is connected to the wireless terminal registration server 20. The operational terminal 30 is used to manage data stored in the wireless terminal registration server 20. Further, the operational terminal 30 is used to perform registration for permitting wireless connection between the wireless terminal 10 and the access points 40 and to perform edition for registering the wireless terminal 10 and the access points 40 or for deleting registration of the wireless terminal 10 and the access points 40.

Each access point 40, which is located in a household or an office, is a wireless communication device provided with a wireless communication function. The access point 40 performs wireless communication with the wireless terminal 10. The access point 40, which includes a CPU, a RAM, and a ROM (not shown), performs processing including a step of performing connection authorization, a step of transmitting a connection authorization request, and a step of registering a wireless terminal identifier in an authorization data storage unit. The wireless terminal registration server 20 executes management programs to function as connection authorization unit, an authorization request transmission unit, and a registration unit for registering a wireless terminal identifier in the authorization data storage unit.

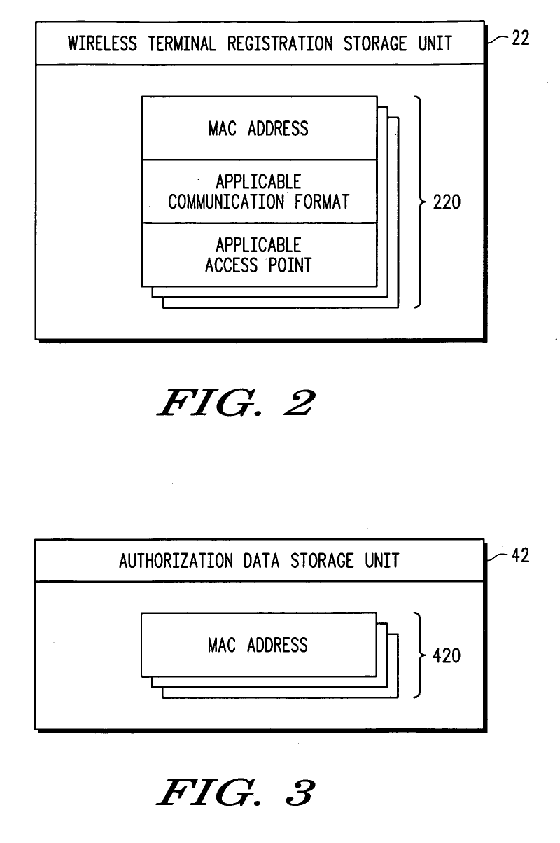

The access point 40 includes an authorization data storage unit 42. As shown in FIG. 3, the authorization data storage unit 42 stores authorization data 420 relating to the wireless terminal 10 that is permitted to use the access point 40. The authorization data 420 is stored in the authorization data storage unit 42 when the wireless terminal 10 is newly registered. The authorization data 420 is deleted when, for example, the wireless terminal 10 is discarded, that is, when an instruction to delete the authorization data 420 is received from the wireless terminal registration server 20. The authorization data 420 includes data relating to the MAC address of each network card included in the wireless terminal 10 that is permitted to use the access point 40.

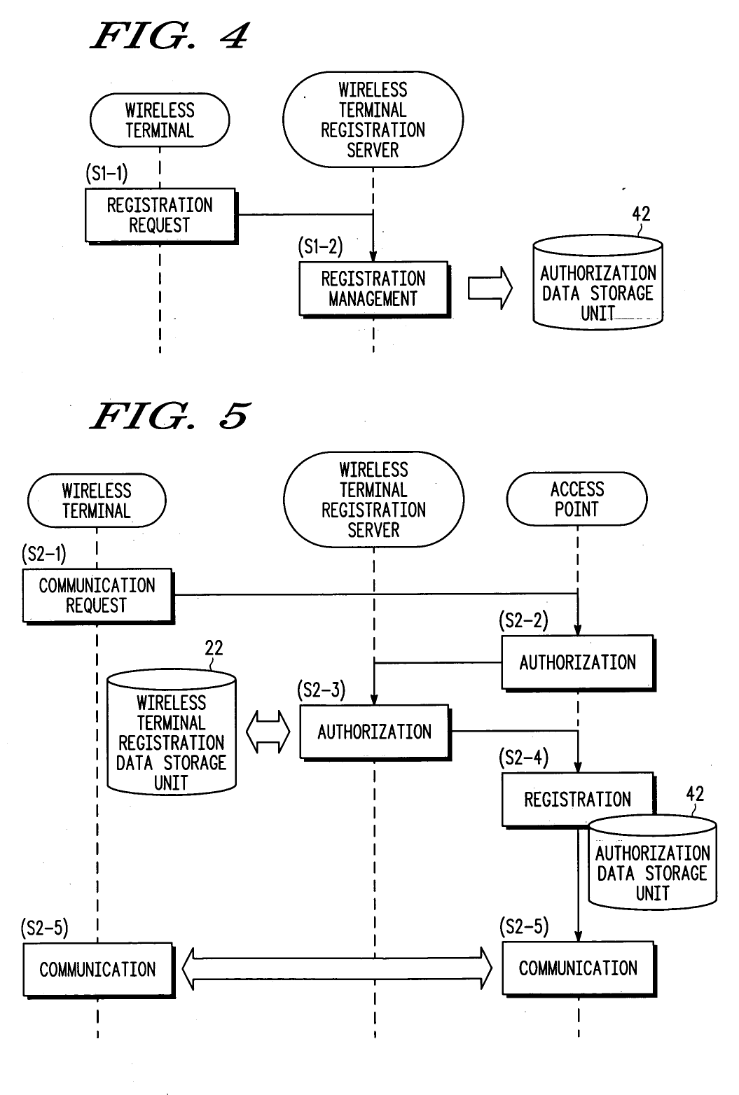

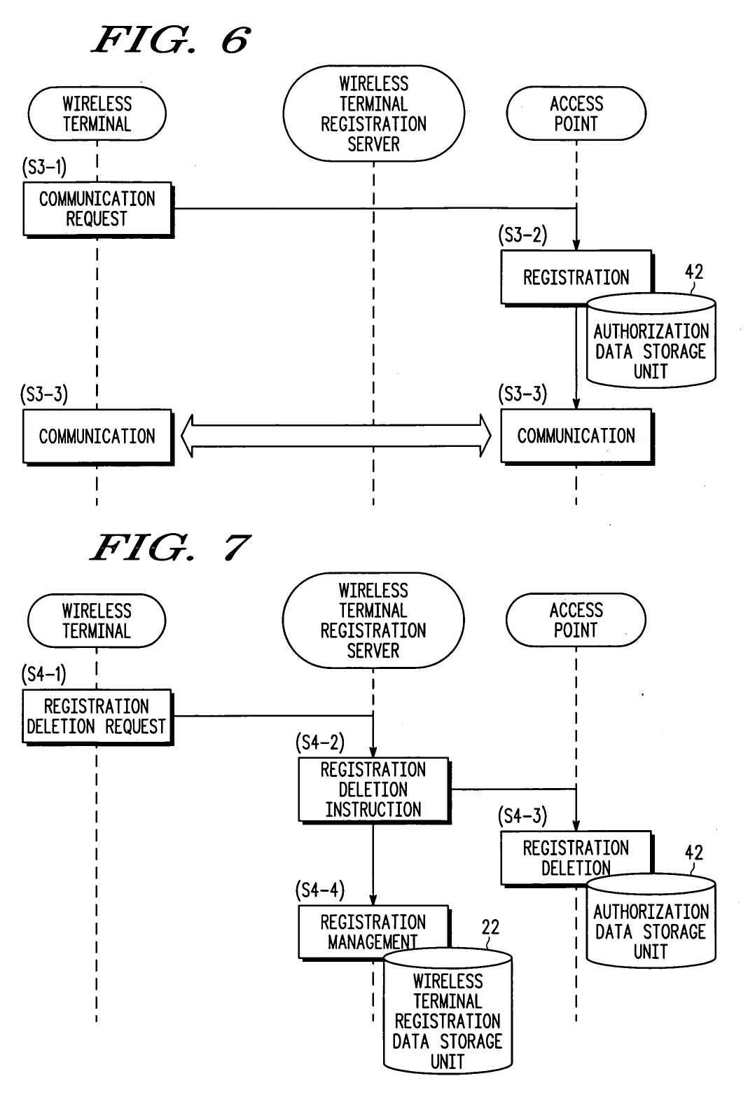

The processing for connection authorization performed between the access point 40 and the wireless terminal 10 using the system described above will now be described. The processing for connection authorization will be described in the order of a registration process (FIG. 4), a connection authorization process (FIGS. 5 and 6), and a deletion process (FIG. 7).

[Registration Process]

First, the registration process for newly registering A wireless terminal 10 will be described with reference to FIG. 4.

The wireless terminal 10 executes a registration request process (step S1-1). More specifically, the wireless terminal 10 is connected by wire or wirelessly connected to the wireless terminal registration server 20. Then, the wireless terminal 10 transmits a registration request to the wireless terminal registration server 20. The registration request includes data related to the communication format and the MAC address of the network card included in the wireless terminal 10. When the wireless terminal 10 includes a plurality of network cards, the registration request includes data for the MAC address of each of the plurality of network cards.

The wireless terminal registration server 20 that has received the registration request executes a registration management process (step S1-2). More specifically, the wireless terminal registration server 20 generates new authorization data 420 using the communication format of the network card included in the received registration request as the applicable communication format. The wireless terminal registration server 20 stores the generated authorization data 420 in the wireless terminal data storage unit 22. To limit access points 40 that may be used by the wireless terminal 10, the registrant operates the operational terminal 30 and records in the applicable access point data region of the wireless terminal registration data 220 the identifiers of the access points 40 that can be used.

The operational terminal 30 may be used from the beginning of the registration process. In this case, the MAC address of the network card included in the wireless terminal 10 must be obtained in advance and registered in the wireless terminal data storage unit 22 associated with the communication format of the network card.

[Connection Authorization Process]

Next, the connection authorization process will be described with reference to FIGS. 5 and 6.

First, the wireless terminal 10 sends a communication request to a specific access point 40 (step S2-1). More specifically, the wireless terminal 10 is arranged within an area that can be reached by radio waves transmitted from the specific access point 40. The wireless terminal 10 is operated to transmit a communication request to the access point 40. The communication request includes data related to the MAC address of the network card included in the wireless terminal 10.

The access point 40 that has received the communication request executes an authorization process (step S2-2). More specifically, the access point 40 first checks whether data of the received MAC address is stored in its authorization data storage unit 42. When the data is stored in the authorization data storage unit 42, the process shown in FIG. 6, which will be described later, is performed. It is assumed here that the access point 40 is accessed for the first time by the wireless terminal 10 that has just been newly registered. In such a case, the data related to the MAC address of the network card included in the newly registered wireless terminal 10 has not been recorded in the authorization data storage unit 42. Thus, the access point 40 transmits a connection authorization request to the wireless terminal registration server 20. The connection authorization request includes the data related to the MAC address of the network card included in the wireless terminal 10.

The wireless terminal registration server 20 that has received the connection authorization request executes an authorization process (step S2-3). More specifically, the wireless terminal registration server 20 checks whether the received MAC address is stored in the wireless terminal data storage unit 22 associated with the identifier of the access point 40. The wireless terminal registration server 20 notifies the access point 40 whether the wireless terminal 10 is permitted to be connected to the access point 40 based on the authorization result. When the wireless terminal registration data 220 including the received MAC address has been registered, the wireless terminal registration server 20 sends a connection permission notice to the access point 40. When the received MAC address has not been registered in the wireless terminal data storage unit 22, the wireless terminal registration server 20 sends a connection denial notice to the access point 40.

The access point 40, which has received the connection permission, registers the data related to the MAC address of the wireless terminal 10 of which connection has been permitted in the authorization data storage unit 42 (step S2-4). Then, the access point 40 starts wireless communication with the wireless terminal 10 (step S2-5).

A connection authorization process performed the next time between the wireless terminal 10 and the access point 40 will be described with reference to FIG. 6. As in the connection authorization process described above, the wireless terminal 10 first executes a communication request process with a certain access point 40 (step S3-1). The communication request includes data related to the MAC address of the network card included in the wireless terminal 10.

The access point 40 that has received the communication request executes an authorization process (step S3-2). The access point 40 checks whether data related to the received MAC address is stored in the authorization data storage unit 42. In this stage, the process shown in FIG. 5 had already been performed. Thus, the data related to the MAC address of the wireless terminal 10 has already been stored in the authorization data storage unit 42. In this case, the access point 40 promptly starts wireless communication with the wireless terminal 10 (step S3-3). When the data related to the MAC address of the wireless terminal 10 is not stored in the authorization data storage unit 42, the process shown in FIG. 5 is performed.

[Registration Deletion Process]

Next, a registration deletion process will be described with reference to FIG. 7.

First, the wireless terminal 10 executes a registration deletion request process (step S4-1). More specifically, the wireless terminal 10 is connected by a wire or wirelessly connected to the wireless terminal registration server 20. In this case, the wireless terminal 10 transmits a registration deletion request to the wireless terminal registration server 20. The registration deletion request includes data related to the communication format and the MAC address of the network card included in the wireless terminal 10.

In the same manner as in the registration request process, the operational terminal 30 may also be used from the beginning of the registration deletion process. In this case, the wireless terminal registration server 20 must be accessed first to obtain a list of the registered MAC addresses. Then, the operational terminal 30 specifies the MAC address that is to be deleted from the list and transmits a registration deletion request that includes the specified MAC address.

The wireless terminal registration server 20 that has received the registration deletion request executes registration deletion instruction process (step S4-2). More specifically, the wireless terminal registration server 20 extracts data of the MAC address included in the received registration deletion request from the wireless terminal registration data 220. The wireless terminal registration server 20 then locates the applicable access points included in the wireless terminal registration data 220. The wireless terminal registration server 20 transmits a deletion instruction to the specified access points 40 to delete the authorization data 420 stored in the authorization data storage units 42. The deletion instruction includes the MAC address included in the registration deletion request.

Each access point 40 that has received the deletion instruction executes a registration deletion process (step S4-3). More specifically, the access point 40 deletes the authorization data 420 of the MAC address included in the deletion instruction from its authorization data storage unit 42.

The wireless terminal registration server 20 also deletes the wireless terminal registration data 220 stored in the wireless terminal data storage unit 22.

The preferred embodiment has the advantages described below.

In the preferred embodiment, the wireless terminal registration server 20 includes the wireless terminal data storage unit 22. The wireless terminal data storage unit 22 stores the wireless terminal registration data 220 related to the wireless terminal 10 that is permitted to access the access points 40. The wireless terminal registration data 220 includes the MAC address, applicable communication format, and applicable access points for each network card included in the wireless terminal 10. An access point 40 that has received a communication request from the wireless terminal 10 transmits a connection authorization request to the wireless terminal registration server 20. The wireless terminal registration server 20 executes the authorization process (step S2-3). The access point 40 that has received a connection permission from the wireless terminal registration server 20 starts wireless communication with the wireless terminal 10 (.step S2-5). In this way, a single registration of the wireless terminal 10 in the wireless terminal registration server 20 enables the wireless terminal 10 to wirelessly communicate with a plurality of access points 40. Further, the editing of the authorization data 420 stored in the authorization data storage unit 42 of the wireless terminal registration server 20 enables simple management of connection settings and connection deletions.

In the preferred embodiment, each access point 40 includes the authorization data storage unit 42. The authorization data storage unit 42 stores the authorization data 420 related to the wireless terminal 10 that is permitted to access the access point 40. The authorization data 420 includes data related to the MAC address of the network card included in the wireless terminal 10 that is permitted to access the access point 40. The access point 40 that has received a connection permission from the wireless terminal registration server 20 registers the data related to the MAC address of the wireless terminal 10 of which connection has been permitted in the authorization data storage unit 42 (step S2-4). Then, when receiving a communication request, the access point 40 executes the authorization (step S3-2). The access point 40 checks whether the data of the received MAC address is stored in its authorization data storage unit 42. If the access point 40 has been accessed at least once by the wireless terminal 10, the access point 40 performs authorization with the authorization data storage unit 42. Thus, connection authorization is efficiently performed.

The data related to the wireless terminal 10 is registered in the authorization data storage unit 42 of the access point 40 only if the wireless terminal 10 has transmitted a connection request to the access point 40. Thus, the data related to the wireless terminal 10 is not registered in the authorization data storage unit 42 of the access point 40 as long as it has not been accessed by the wireless terminal 10. This avoids unnecessary registration of the data relating to the wireless terminal 10 in the authorization data storage units 42 of the access points 40.

In the preferred embodiment, the wireless terminal registration data 220 stored in the wireless terminal data storage unit 22 includes data of applicable access points in association with the network card included in the wireless terminal 10. The wireless terminal registration server 20 checks whether a received MAC address stored in the wireless terminal data storage unit 22 is associated with the identifiers of the access points 40. This limits the wireless terminal 10 that are connectable to the access points 40.

In the preferred embodiment, the wireless terminal registration server 20 that has received a registration deletion request executes the registration deletion instruction process (step S4-2). More specifically, the wireless terminal registration server 20 transmits to the applicable access points 40 a deletion instruction for deleting the authorization data 420 stored in the authorization data storage units 42. This enables effective use of storage capacity of the access points 40 and prevents erroneous authorization of wireless terminals 10 that are no longer registered.

It should be apparent to those skilled in the art that the present invention may be embodied in many other specific forms without departing from the spirit or scope of the invention. Particularly, it should be understood that the present invention may be embodied in the following forms.

In the preferred embodiment, data related to the MAC address of the network card included in the wireless terminal 10 is used in the authorization process. However, the data used in the authorization process is not limited to the MAC address and may be any data that identifies the individual terminal or the individual user.

In the preferred embodiment, the wireless terminal registration server 20 that has received a registration deletion request executes the registration deletion instruction (step S4-2). More specifically, the wireless terminal registration server 20 transmits to each access point, of which data is stored in the wireless terminal data storage unit 22, a deletion instruction for deleting the authorization data 420 stored in the authorization data storage unit 42. This process may be used to change applicable access points. More specifically, when the wireless terminal registration data 220 stored in the wireless terminal data storage unit 22 is changed by the operational terminal 30, a deletion instruction for deleting the authorization data 420 stored in the authorization data storage unit 42 is transmitted to the access point 40 that is to be deleted in accordance with the change. Further, when changing the wireless terminal registration data 220 to register a new applicable access point 40, the wireless terminal registration server 20 executes the authorization process (step S2-3) when receiving a connection authorization request. This enables the setting of the wireless terminal registration data 220 to be changed in a flexible manner with the operational terminal 30.

In the preferred embodiment, the wireless terminal registration server 20 that has received a registration deletion request executes the registration deletion instruction process (step S4-2). More specifically, the wireless terminal registration server 20 extracts the wireless terminal registration data 220 including the MAC address that is included in the received registration deletion request. The wireless terminal registration server 20 then specifies the applicable access points included in the wireless terminal registration data 220. The wireless terminal registration server 20 then transmits to the specified applicable access points a deletion instruction for deleting the authorization data 420 stored in the authorization data storage units 42. Instead of such a process, the wireless terminal registration server 20 may transmit to all of the access points that are connected by the network a deletion instruction for deleting the authorization data 420 stored in the authorization data storage units 42. This enables the registration deletion process to be executed regardless of whether the wireless terminal registration data 220 includes no data of the applicable access points.

The present examples and embodiments are to be considered as illustrative and not restrictive, and the invention is not to be limited to the details given herein, but may be modified within the scope and equivalence of the appended claims.

1. A connection management system for performing wireless terminal connection authorization through wireless communication, the system comprising:
a wireless terminal registration server including a registration data storage means for storing data related to a wireless terminal identifier that permits connection;
an access point connected to the wireless terminal registration server through a network; and
a wireless terminal for performing wireless communication with the access point, the access point including:
an authorization data storage means for storing the data related to the wireless terminal identifier that permits connection;
a means for performing connection authorization when receiving a connection request including data related to the wireless terminal identifier from the wireless terminal based on whether the wireless terminal identifier has been registered in the authorization data storage unit;
a means for transmitting a connection authorization request including the data related to the wireless terminal identifier to the wireless terminal registration server when the connection authorization is unsuccessful; and
a means for registering the wireless terminal identifier in the authorization data storage means when receiving a connection permission from the wireless terminal registration server based on registration of the wireless terminal identifier in the registration data storage means.

2. The connection management system according claim 1, wherein:
the registration data storage means further stores data related to an access point identifier for permitting connection in association with the wireless terminal identifier; and
the wireless terminal registration server locates the access point that has transmitted the connection authorization request and includes a means for transmitting the connection permission when the wireless terminal identifier included in the connection authorization request is stored in the registration data storage means in association with the access point identifier.

3. The connection management system according to claim 1, wherein the wireless terminal registration server further includes a correcting means for changing registration information of the registration data storage means to change the wireless terminal for which connection is permitted.

4. The connection management system according to claim 1, wherein the wireless terminal registration server includes a change instruction means for transmitting, when registration information stored in the registration data storage unit is changed, a change instruction related to the wireless terminal identifier of which registration information has been changed, to the access point.

5. The connection management system according to claim 4, wherein the change instruction means transmits a change instruction to the access point associated with the wireless terminal identifier of which registration information has been changed.

6. A connection management program for performing wireless terminal connection authorization through wireless communication with:
a wireless terminal registration server including a registration data storage means for storing data related to a wireless terminal identifier that permits connection;
an access point connected to the wireless terminal registration server through a network and including an authorization data storage means for storing the data related to the wireless terminal identifier that permits connection; and
a wireless terminal for performing wireless communication with the access point, the program when executed causing the access point to function as:
a means for performing connection authorization when receiving a connection request including data related to the wireless terminal identifier from the wireless terminal based on whether the wireless terminal identifier has been registered in the authorization data storage unit;
a means for transmitting a connection authorization request including the data related to the wireless terminal identifier to the wireless terminal registration server when the connection authorization is unsuccessful; and
a means for registering the wireless terminal identifier in the authorization data storage means when receiving a connection permission from the wireless terminal registration server based on registration of the wireless terminal identifier in the registration data storage means.

7. A method for performing wireless terminal connection authorization through wireless communication with:
a wireless terminal registration server including a registration data storage means for storing data related to a wireless terminal identifier that permits connection;
an access point connected to the wireless terminal registration server through a network and including an authorization data storage means for storing the data related to the wireless terminal identifier that permits connection; and
a wireless terminal for performing wireless communication with the access point, the method having the access point execute the steps of:
performing connection authorization when receiving a connection request including data related to the wireless terminal identifier from the wireless terminal based on whether the wireless terminal identifier has been registered in the authorization data storage unit;
transmitting a connection authorization request including the data related to the wireless terminal identifier to the wireless terminal registration server when the connection authorization is unsuccessful; and
registering the wireless terminal identifier in the authorization data storage means when receiving a connection permission from the wireless terminal registration server based on registration of the wireless terminal identifier in the registration data storage means.
